(19) United States
(12) Patent Application Publication
(10) Pub. No.: US 2007/0298242 A1
(43) Pub. Date: Dec. 27, 2007

(54) LENSES HAVING DISPERSED METAL NANOPARTICLES FOR OPTICAL FILTERING INCLUDING SUNGLASSES

(75) Inventor: Qun Huo, Orlando, FL (US)

Correspondence Address: AKERMAN SENTERFITT, P.O. BOX 3188, WEST PALM BEACH, FL, 33402-3188, US

(73) Assignee: UNIVERSITY OF CENTRAL FLORIDA RESEARCH FOUNDATION, INC., Orlando, FL (US)

(21) Appl. No.: 11/768,561

(22) Filed: Jun. 26, 2007

Related U.S. Application Data
(60) Provisional application No. 60/816,572, filed on Jun. 26, 2006.

(51) Int. Cl. B32B 5/16; B32B 27/36; B32B 27/30

(52) U.S. Cl. 428/323; 428/426; 428/412; 428/522; 428/323

(57) ABSTRACT

Lenses appropriate for use as sunglasses and other optical filtering devices include one or more composite layers including metal nanoparticles dispensed in a polymer matrix. The entire lens can be a single layer of the composite or the composite can be a coating on one or both faces of the lens. Gold nanoparticles can be dispersed in a poly(methylmethacrylate) or polycarbonate polymer at 0.01 to 1 weight percent.

### CROSS-REFERENCE TO RELATED APPLICATIONS

The present application incorporates by reference and claims priority to U.S. Provisional Patent Application Ser. No. 60/819,572 filed Jun. 26, 2006, entitled “Nanoparticle Sunglasses”.

### STATEMENT REGARDING FEDERALLY SPONSORED RESEARCH OR DEVELOPMENT

The U.S. Government may have certain rights to the invention based on National Science Foundation DMR 0552295 and DMI 0506531.

### FIELD OF THE INVENTION

The present invention relates to light attenuating lenses including eye protection glasses, such as sunglasses.

### BACKGROUND OF THE INVENTION

The spectrum of electromagnetic radiation from the sun which reaches the earth's surface ranges in wavelength from about 0.01 nanometers to over 1 million kilometers and includes infrared, visible light, ultra-violet light, x-rays, and gamma rays. The visible light range is generally defined as those wavelengths in the 400 to 700 nanometer range.

Visible light from the sun is scattered and reflected as it enters the atmosphere, oftentimes causing a dazzling brightness which can cause visual discomfort. When light strikes a flat surface, part of the light is reflected from this surface and part of the light is absorbed. The light that is reflected can produce a very harsh, bright, dazzling light which is commonly referred to as glare.

Electromagnetic radiation with wavelengths of approximately 700 to 1,400 nanometers is part of the invisible near infrared spectrum. Because near IR light can penetrate much deeper in biological tissue than UV and visible light, damage caused by near IR light exposure, particularly to retina, is even more severe than UV and visible light. Commonly used and commercial available sunglasses do not contain components for protection against near IR irradiation.

Wavelengths shorter than 400 nanometers fall below the visible light spectrum and represent the ultraviolet light spectrum. Excessive exposure of the eyes to ultraviolet can cause damage to the cornea and the lens of the eye. Most concern over possible damage to the eye involves the band of ultraviolet light known as UVB which are wavelengths from 290 to 315 nanometers. The longer wavelengths of ultraviolet light, from 315 nanometers to 380 nanometers, are referred to as UVA. These wavelengths can also be detrimental, but much less so than UVB.

Part of the UVB, including all wavelengths shorter than 295 nanometers, are absorbed by the cornea, the transparent tissue that covers the colored iris and pupil of the eye. Although ultraviolet rays damage corneal cells, the cornea repairs itself so rapidly that it usually keeps up with the assault. However, prolonged ultra-violet exposure can overwhelm the cornea's repair processes causing temporary blindness. Even so, the cornea will usually recover within a few days.

The chief concern about ultraviolet damage, centers on the lens of the eye. Lifetime exposure to ultraviolet radiation contributes to some types of cataracts. The human eye is for all practical purposes, an ultraviolet filter. The lens of the eye absorbs all the UVA plus any UVB not blocked by the cornea. The lens thus shields the light sensitive retina at the back of the eye from the ultraviolet rays, but possibly places itself at risk in the process.

Sunglasses have lenses which are generally manufactured from glass or synthetic materials. These lenses may have the light absorbing dyes and ultraviolet inhibiting chemicals mixed into the lens materials or coated on the surface of the lens. Glass lenses are scratch resistant, non-warping and usually distortion free. Synthetic lenses are light, virtually shatterproof and generally less expensive.

A common feature on many sunglasses is a mirrored surface. Mirroring is accomplished by applying a thin coating of a transparent light reflective metal oxide coating to the lens which reflects some of the bright light and also reflects much of the heat created by the infrared rays. This feature also reflects some of the ultraviolet light.

Although sunglasses are available which provide some eye protection to UVA, UVB and blue light, there is a need for higher levels of protection against a wider range of harmful electromagnetic wave irradiation, including UVA, UVB, blue light and near IR light. The sunglasses should also be scratch-resistant and producible at low cost, have long-term stability, and provide high levels of optical clarity.

### SUMMARY OF THE INVENTION

The invention is directed to lenses for optical filtering and can be used for lenses of sunglasses. The lenses have at least one layer that is a composite of a discontinuous metal nanoparticle phase dispersed randomly to give a uniform dispersion in a continuous polymer phase. The average size of the metal nanoparticles is from 1 to 999 nm. The shape of the nanoparticles can be spherical, rod-like, prism-like, core-shell structures or other regular and irregular shapes. The nanoparticles in the composite can be loaded at levels of 0.01 to 10 percent by weight. A given lens can be formed as a single composite of the metal nanoparticles in the polymer phase or can be formed by coating the top and/or bottom surface of a plastic or glass lens with the nanoparticles or nanoparticle/polymer composite. The lens can exist as a stack of laminate layers where one or more of the layers is a metal nanoparticle/polymer composite. The lens can also include dyes traditionally used for sunglasses in addition to the metal nanoparticles for light filtering where the dye can be incorporated into the metal nanoparticle/polymer composite layer or in a layer coated by the composite or in a layer of a laminate structure other than the composite layer. The metal nanoparticle/polymer composite can be formed with noble metal nanoparticles dispersed in a thermoplastic. The noble metal is preferably silver or gold, and most preferably gold. In one embodiment the polymer is a thermoplastic. The thermoplastic is preferably poly(methylmethacrylate) or polycarbonate. Sunglasses with good UVB, UVA, blue light and near IR protection can be formed form lenses including one or more layers of a metal nanoparticle/polymer composite by fixing a pair of lenses into a frame for securing the lenses to the head of a wearer.

### BRIEF DESCRIPTION OF THE DRAWINGS

A fuller understanding of the present invention and the features and benefits thereof will be obtained upon review of the following detailed description together with the accompanying drawings, in which:

FIG. 1 shows cross-sections of three exemplary lenses of the present invention where: a) is a lens where the entire lens comprises a metal nanoparticle/polymer composite; b) is a lens that is coated with a composite according to the invention on the top surface of the lens; and c) is a seven layer laminate lens with three metal/nanoparticle composite layers individually dispersed between four lenses that do not contain nanoparticles.

FIG. 2 shows a sunglasses embodiment of the present invention.

### DETAILED DESCRIPTION

Sunglasses according to the invention comprise a pair of lenses, the lenses being a single layer or multiple-layered structure including a nanoparticle/polymer composite and a layer comprising a dispersion of metal nanoparticles in a polymer. The composite layer comprises a continuous phase comprising at least one polymer, and a plurality of metal nanoparticles dispersed in the polymer continuous phase, thus forming a dispersed system. Preferred metals are noble metals such as gold and silver, with gold being the most preferred. As used herein, the metal nanoparticle is essentially a metal at the surface of the nanoparticle, hence metal-inorganic hybrid nanoparticles, for example core-shell nanoparticles such as gold deposited as a shell about a silica core, is included in the metal nanoparticles for use in the invention. The polymer is generally a dry solid in the completely fabricated lens such that the metal nanoparticles are locked in position to resist migration and to avoid the generation of optical defects on the lens surface by physically handling the lens or a device containing the lenses. The polymers are selected to resist the absorption of moisture from the environment such that the finished surfaces of a lens are not adversely altered during common use of the lens, for example as the lenses of sunglasses.

The “dispersed system” is defined herein as consisting essentially of fine insoluble particles throughout a continuous medium where the particles are uniformly and randomly positioned throughout the solid phase medium. The dispersed noble metal nanoparticle systems according to the present invention are clearly distinguishable from nanoparticle systems which feature nanoparticles in clumped, clustered, or otherwise segregated arrangements where the occurrence of particles are not uniformly distributed throughout the bulk of the medium.

The multiple-layered structure can be a conventional optically clear polymer or glass lens coated with a nanoparticle or nanoparticle/polymer composite layer on the surface. A multiple-layer structure can be a stacked laminate structure where at least one layer of the stack is a nanoparticle/polymer composite layer according to the invention.

Although described as being gold nanoparticles, the nanoparticles may also be silver nanoparticle materials, or a mixture of gold, silver and other nanoparticles which have high extinction coefficient at UVA, UVB, blue light and near IR spectral region. As used herein, nanoparticles refers to the average size of the gold or other particles being primarily, and preferably essentially entirely, nanosize (1 to 999 nm), such as having an average size less than 900 nm, 800 nm, 700 nm, 600 nm, 500 nm, 400 nm, 300 nm, 200 nm, 100 nm, or 50 nm. In a preferred embodiment, the average size is 20 to 100 nm. Nanoparticles of the same metal can be used as a mixture with different average sizes, such as 100 nm and 20 nm, to achieve an optical filtering effect. Nanoparticles with different shapes, such as spherical nanoparticles and rod-like nanoparticles, can be combined to achieve a desired optical protection across UVA, UVB, blue light and near IR spectral region. Nanoparticles can be of different types, for example a gold nanoparticle can be used with a core-shell nanoparticle with a silica core surrounded by a gold shell. Nanoparticles of different metals can be used in the practice of the invention.

In addition to the metal nanoparticles, more traditional dyes and metal oxide light absorbers and blockers that are commonly used in state of the art sunglasses can be incorporated into the lenses. These additional light modifying agents can be dispersed in the polymer phase with the metal nanoparticles or can reside is a second layer of a laminate, or in a bulk lens material that is coated with the metal nanoparticles or a nanoparticle/polymer composite layer.

The metal nanoparticles generally provide the desired light attenuation on filtering at levels below 1 percent by weight to about 0.01 percent by weight of the composite. For most applications this level can be below 0.5 percent by weight. Typically, levels in excess of 0.05 percent by weight are used to give a sufficient level of light attenuation or filtering and a preferred range of nanoparticle concentrations is generally from 0.05 to 0.5 percent by volume.

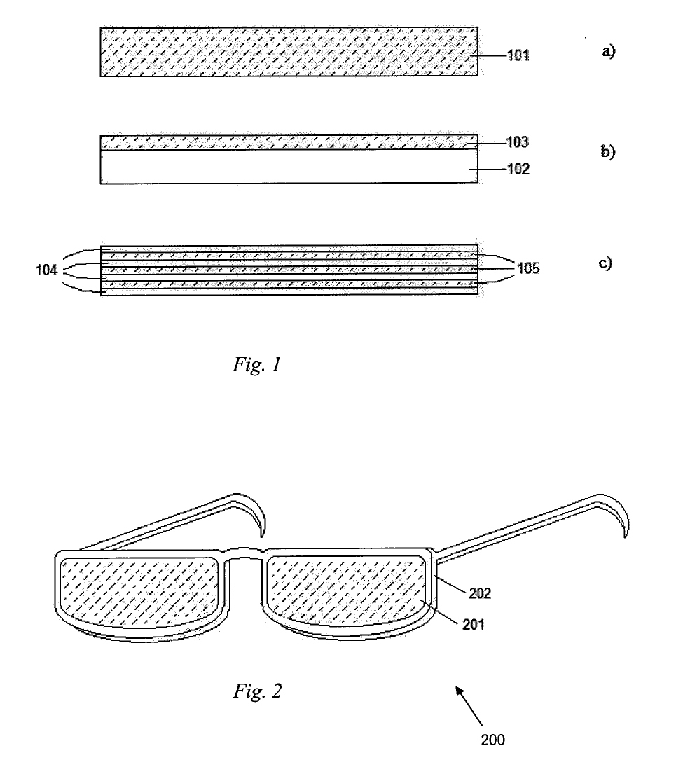

FIG. 1a) shows a substantially flat lens where the entire lens according to the embodiment of the present invention is a metal nanoparticle/polymer composite 101. FIG. 1b) shows a substantially flat lens where a lens material 102 that is generally a glass or a plastic is coated on the top surface with a metal nanoparticle/polymer composite layer 103. FIG. 1c) shows a substantially flat lens where four layers of glass or plastic 104 alternate with three nanoparticle/polymer composite layers 105. Although substantially flat lenses are illustrated in FIG. 1, the lenses can also be concave, convex or any other shape required for the glasses or other device which includes one or more of the lenses of the present invention.

Embodied as sunglasses 200, as illustrated in FIG. 2, frames 202 holding a pair of lenses according to the present invention 201 are provided having a structure for securing the sunglasses to the head of a wearer. As known in the art, frames can be generally made from plastic, nylon, a metal or metal alloy. Nylon frames are light weight and flexible and able to bend slightly and return to their original shape instead of breaking when pressure is applied to them.

Sunglasses according to the invention provide maximum protection against a range of harmful electromagnetic wave irradiation wider than available sunglasses. By providing a high extinction coefficient towards UVA, UVB, blue light and near IR light, sunglasses according to the invention filter off these four most harmful solar irradiations to safe levels as defined by ANSI standards. The long-term protection effect of the nanoparticle sunglasses is significantly improved compared to the existing sun-block molecule-based sunglasses due to the much better photophysical and photochemical stability of nanoparticles compared to conventional organic sun-block molecules. Organic sun-block molecules tend to degrade after elongated exposure to sunlight, leading to a decrease in sun-block efficiency. In contrast, metal nanoparticles are much more stable under sunlight exposure as compared to than organic molecules. Furthermore, sunglasses formed from composites according to the invention can protect eyes from damage of laser irradiation to a certain energy level due to the optical limiting effect of metal nanoparticles, which can be very important for military and commercial airline pilots. The nanoparticle polymer composites based sunglasses are also more scratch-resistant and can last much longer than the currently available plastic sunglasses. The cost for producing nanoparticle glasses according to the invention are generally comparable to most commercial available plastic sunglasses.

The lenses can be formed using simple and inexpensive methods, such as the exemplary methods describe below. In a first exemplary embodiment, the nanoparticles and the polymer are preferably prepared separately. The polymer and metal (e.g. Au) nanoparticles can both be obtained from commercial sources. Preferred polymers include poly(methyl methacrylate) and polycarbonate which are approved and currently are used extensively for sunglasses manufacturing. Fillers, antioxidants and other additives can be present in the polymers.

The polymer and nanoparticles are mixed together in a solvent. Alternatively, a polymer/nanoparticle mixture may also be prepared by mixing nanoparticles into the molten polymer. Generally a dispersing agent is applied to the nanoparticles such that the agglomeration of the nanoparticles is inhibited and a good dispersion of nanoparticles in the polymer matrix is achieved. The dispersing agent can be a complexing agent, surfactant, polymer, dye, protein, DNA, or any other chemical or materials that make the nanoparticle soluble and stable. Common dispersing agents that can be employed include surfactants, oleylamine and alkanethiols. The metal nanoparticles can be dispersed in the polymers in a fluid state, either in the melt or in a solution of the polymer. Typically an organic solvent for the polymer is employed for a solution dispersing method. Any known dispersion technique can be employed to disperse the metal nanoparticles in the liquid polymer including mixing, shaking, or sonicating.

A lens according to the invention can be formed by simply casting the liquid nanoparticle/polymer mixture in a suitable mold or other container. When a solution is used to form the composite the solvent is removed to fix the lens. When a melt is used to form the composite, cooling results in the fixing of the lens. After drying or cooling, the lenses is obtained in a stable form where the nanoparticles are essentially fixed in a uniform but random manner in the composite layer. A second exemplary method involves coating a nanoparticle/polymer solution on a pre-made clear polymer or glass lens using spin coating, spray painting, or other film coating techniques. Alternately, at least one nanoparticle/polymer composite layer can be formed and fused with one or more other glass or polymer layers free of metal nanoparticles to form a laminate lens. The fusion of layers can be carried out with heating (e.g. room temperature) under a compressive force applied to the desired stack of layers. Since the nanoparticles are generally prepared prior to addition to the polymer matrix, there are no added impurities trapped inside the film, such as those that result from composites formed using in situ formation of the nanoparticle such as from a metal salt precursor. Accordingly, metal nanoparticle comprising films adapted for lenses according to the present invention are generally essentially free of salt, salt residue and other impurities which can adversely impact mechanical and optical properties (e.g. clarity). Using the methods described above, films according to the present invention have been found to provide predictable mechanical and optical properties.

The advantage of using metal nanoparticles as a sun-blocker for sunglasses and other sun and laser-blocking product according to the present invention is demonstrated by the following optical characteristics. As known in the art, the sun-block efficiency of an optical material is directly related to the extinction coefficient of the material at a particular wavelength. Overall, it has been reported that the cross section and the extinction coefficient of certain metal nanoparticles can be orders of magnitude higher than typical organic dye molecules. Significantly, the present invention has found that gold nanoparticles with a cross section (e.g. diameter) of 10 s of nanometers, such as 20-100 nm, exhibit a strong absorption around and below 520 nm. The extinction coefficient of a 40 nm gold nanoparticle is around 7.66×10⁹ M⁻¹cm⁻¹, which is five orders of magnitude higher than the molar extinction coefficient of a typical dye molecule, indocyanine green (ε=1.08×10⁴ M⁻¹cm⁻¹). Gold nanorods with dimension of 15 nm by 40-50 nm exhibit strong surface plasmon resonance absorption at 520 nm and 780 nm, extending to higher than 1000 nm. Core-shell structured metal-inorganic hybrid particles such silica (core)-gold (shell) nanoparticles can have tunable absorption from visible to the whole near IR region, i.e. 1400 nm. Metal nanoparticles such as gold and silver also exhibit nonlinear optical properties that most organic sun-blocking molecules lack. For example, the present invention has found at an incident laser energy with a fluence of 1 J/cm, a gold nanoparticle solution can block about 50% of the laser irradiation, as discovered in the inventor's research.

Although described as being used for sunglasses, the nanoparticle/polymer composite materials according to the invention can be used for other purposes. For example, the invention can be used for the lenses of ordinary glasses as well as goggles. Such composite materials may also be applied to glass windows as a window treatment to block excessive sunlight irradiation, or applied to the window of a scientific instrument or weapon to protect the instrument and weapon from laser damage.

This invention can be embodied in other forms without departing from the spirit or essential attributes thereof and, accordingly, reference should be had to the following claims rather than the foregoing specification as indicating the scope of the invention.

I claim:

1. A lens for optical filtering, comprising at least one composite layer, said composite layer comprising:
a continuous phase comprising a polymer, and
a discontinuous phase comprising a plurality of metal nanoparticles dispersed in said continuous phase, wherein an average size of said nanoparticles is from 1 to 999 nm.

2. The lens of claim 1, wherein said lens comprises a single layer comprising said composite.

3. The lens of claim 1, wherein said lens comprises said composite layer coating on at least one side of a polymer or a glass layer.

4. The lens of claim 1, wherein said composite layer consists essentially of said polymer continuous phase and said metal nanoparticles.

5. The lens of claim 1, wherein said polymer comprises poly(methylmethacrylate) or polycarbonate.

6. The lens of claim 1, wherein said metal nanoparticles comprise gold nanoparticles.

7. The lens of claim 1, wherein said metal nanoparticles comprise 0.01 to 1 weight percent of said composite.

8. The lens of claim 1, wherein said composite further comprises at least one dye.

9. Nanoparticle sunglasses, comprising
a pair of lenses, said lenses comprising at least one composite layer, said composite layer comprising:
a continuous phase comprising a polymer;
a discontinuous phase comprising a plurality of metal nanoparticles dispersed in said continuous phase, wherein an average size of said metal nanoparticles is from 1 to 999 nm, and
frames holding said pair of lenses having structure for securing said sunglasses to the head of a wearer.

10. The nanoparticle sunglasses of claim 9, wherein said lenses are a single layer comprising said composite layer.

11. The nanoparticle sunglasses of claim 9, wherein said lenses comprises said composite layer coating on at least one side of a polymer or a glass layer.

12. The nanoparticle sunglasses of claim 9, wherein said polymer comprises poly(methyl methacrylate) or polycarbonate.

13. The nanoparticle sunglasses of claim 9, wherein said metal nanoparticles comprise gold nanoparticles.

14. Nanoparticle sunglasses comprising:
a pair of lenses, said lenses comprising a plurality of gold nanoparticles dispersed in a polymeric phase, wherein an average cross sectional size of said nanoparticles is from 20 to 100 nm and the weight percent of nanoparticles is 0.01 to 1; and
frames holding said pair of lenses having structure for securing said sunglasses to the head of a wearer.

15. The nanoparticle sunglasses of claim 14, wherein said polymer comprises polycarbonate.

16. The nanoparticle sunglasses of claim 14, wherein said polymer comprises poly(methylmethacrylate).
